(19) United States
(12) Patent Application Publication
(10) Pub. No.: US 2007/0259133 A1
(43) Pub. Date: Nov. 8, 2007

(54) Ordered Alloy Phase Nanoparticle, Method of Manufacturing the Same Ultra-High-Density Magnetic Recording Medium, and Method of Manufacturing the Same

(75) Inventors: Teruo Ono, Uji-shi (JP); Shinpei Yamamoto, Uji-shi (JP); Yasumasa Morimoto, Uji-shi (JP); Mikio Takano, Uji-shi (JP)

Correspondence Address: OLIFF & BERRIDGE, PLC, P.O. BOX 19928, ALEXANDRIA, VA, 22320, US

(73) Assignee: KYOTO UNIVERSITY, KYOTO (JP)

(21) Appl. No.: 11/793,029

(22) PCT Filed: Dec. 7, 2005
(86) PCT No.: PCT/JP05/22476

§ 371 Date: Jun. 14, 2007

(30) Foreign Application Priority Data
Dec. 27, 2004 (JP) 2004-377455
Apr. 28, 2005 (JP) 2005-132572
Sep. 9, 2005 (JP) 2005-261617

(51) Int. Cl. B29C 35/08; B05D 3/00

(52) U.S. Cl. 427/599; 427/401

(57) ABSTRACT

A FePt alloy nanoparticle, which is expected to be a promising material used for an ultra-high-density magnetic recording medium of the next generation, is ordered by heat treatment to have high magnetic anisotropy, but there has been a problem that the particles are coalesced with each other and agglomerate during the heat treatment. According to the present invention, each particle of the alloy nanoparticles is covered with a coating such as SiO₂, and thereafter a heat treatment for ordering is carried out. In this method, the alloy nanoparticles do not coalesce with each other even if the heat treatment is performed at such a high temperature as to allow all the particles to be fully ordered. After the heat treatment, only the coating is removed using an acid or alkali solution so that it is possible to obtain ordered alloy phase nanoparticles which are ordered and dispersible in various solutions. It is also possible to easily manufacture an ultra-high-density magnetic recording medium by coating surfaces of a substrate with a binder solution in which the particles are dispersed while applying a magnetic field in a predetermined direction.

### TECHNICAL FIELD

The present invention relates to a technique for ordering an alloy nanoparticle without causing agglomeration.

### BACKGROUND ART

To cope with the rapidly developing information society and the demand for miniaturization of devices, there has been a demand for development of an ultra-high-density magnetic recording medium which has a large memory capacity per unit area and can store a larger amount of information.

A material used for magnetic recording media of this kind is primarily required to be a small particle with high magnetic anisotropy. Since it may be said that the storage density of a magnetic recording medium depends on the size of the particle, the particle is desirably as small as possible; however, a smaller volume per particle normally results in a higher chance of magnetization reversal due to the influence of thermal relaxation, causing a problem of deteriorating stability of magnetic recording.

In those circumstances, a FePt nanoparticle has been attracting attention as a material causing no such problems as mentioned above. Normally, a crystal structure of FePt is an fcc structure having a disordered atomic configuration, and by providing heat treatment, the FePt nanoparticle is ordered (a phase change to the L1₀ phase) to have a high magnetic anisotropy.

A temperature of several hundred degrees Celsius or more is required in the heat treatment to change the phase of FePt as mentioned above; herein there is a problem that the heat causes coalescence among FePt nanoparticles, and agglomeration of the particles occurs. Moreover, when an attempt is made to carry out the heat treatment upon forming a coating or after forming a coating on a substrate of a recording medium, since a normal substrate cannot tolerate such a high temperature, it is practically impossible to carry out the heat treatment upon forming a coating or after forming a coating on the substrate.

For solving the aforementioned problems relating to the heat treatment, various techniques have been proposed. For example, Patent Document 1 discloses a magnetic material for a magnetic recording medium in which an element A in the range of 1 to 20 (at. %) by atomic percentage of A/(F+M) is contained in an alloy having a component composition represented by F_{X}M_{100-X}. It is suggested that Si or Al is desirably used as the element A. The existence of the proper amount of element A on the surface of alloy nanoparticles suppresses a phenomenon of coalescence of the particles. However, in this technique, though the degree of coalescence may be reduced, since the distance between the particles is statistically determined, a distribution of particles that causes the coalescence is unavoidably present at a certain rate, and therefore it is not possible to fully prevent the coalescence.

As another known example, Patent Document 2 discloses a technique to change the phase of FePt alloy to an ordered phase having a high magnetic anisotropy even at a low temperature of 300° C. or less by including a slightly higher rate of Pt in the FePt composition. This technique, however, requires various complicated conditions such as the proper selection of materials for forming the substrate and a foundation layer formed on a surface of the substrate. Furthermore, when the heat treatment is carried out at a low temperature, a sufficient ordering does not occur, and thus it is difficult to achieve a high magnetic anisotropy.

Patent Document 3 discloses a method of manufacturing a magnetic recording medium using nanoparticles such as FePt. This document describes, as a method of carrying out ordering of nanoparticles, a crystal-ordering method in which heat treatment is carried out after nanoparticles are filled into the pores of silica gel. With this structure, the nanoparticles are prevented from spreading. Moreover, in order to prevent coalescence of particles during the heat treatment, a vacuum atmosphere is maintained. According to this method, however, it takes as long as approximately two days to fill the nanoparticles into the pores of silica gel, causing the problem of taking too much time. Furthermore, since the nanoparticles may contact one another in each pore, it is not possible to fully prevent the coalescence from occurring during the heat treatment.

Patent Document 3 also discloses a method in which heat treatment is carried out on particles supported by a water-soluble salt such as magnesium sulfate hydrate. In this method, however, the nanoparticles are supported in a state where they are contacting each other, and the particles may coalesce with each other at the contacting site, and therefore, it is not possible to increase the yield of ordered nanoparticles.

Moreover, when a recording medium is produced by using an ordered alloy phase nanoparticle, formation of a coating is in many cases performed by sputtering in those techniques invented so far, including the aforementioned techniques; however, the coating formation by sputtering often causes a problem of irregular particle size. Furthermore, since there is also a problem that this method is more costly as compared to a relatively inexpensive spin coating method it is not desirable from industrial and practical viewpoints.

[Patent Document 1] Japanese Unexamined Patent Application Publication No. 2003-217108

[Patent Document 2] Japanese Unexamined Patent Application Publication No. 2004-311925

[Patent Document 3] Japanese Unexamined Patent Application Publication No. 2004-362746 (Paragraph Nos.[0052]-[0056], [0084]-[0111])

[Non-Patent Document 1] Shouheng Sun et al., “Monodisperse FePt Nanoparticles and Ferromagnetic FePt Nanocrystal Superlattices”, Science, VOL. 287

[Non-Patent Document 2] Hongyou Fan et al., “Self-Assembly of Ordered, Robust, Three-Dimensional Gold Nanocrystal/Silica Arrays”, Science, VOL. 304

[Non-Patent Document 3] Hiroaki Kura et al., “Synthesis of L1₀-(Fe_{y}Pt_{100-y})₁₀₀₋ₓCuₓ nanoparticles with high coercivity by annealing at 400° C.”, Journal of applied physics, Volume 96, Number 10

### DISCLOSURE OF THE INVENTION

Problem to be Solved by the Invention

A problem to be solved by the present invention is to provide a simple method of obtaining an ordered alloy phase nanoparticle which does not coalesce with each other and has a high magnetic anisotropy.

Means for Solving the Problems

To solve the aforementioned problems, the method of manufacturing an ordered alloy phase nanoparticle according to the present invention, includes: a coating process for covering each of the alloy nanoparticle with a coating; a heat treatment process for carrying out a heat treatment for ordering the structure of the alloy nanoparticle; and a coating removal process for removing the coating.

### EFFECT OF THE INVENTION

According to the method of manufacturing an ordered alloy phase nanoparticle of the present invention, since each nanoparticle is covered with a coating, the nanoparticle inside the coating does not coalesce with each other when heat treatment for ordering is carried out. By removing only the coating after the heat treatment, it is possible to easily obtain an ordered alloy phase nanoparticle having a uniform size, in which an individual particle is present independently without coalescing with each other.

Moreover, it is so far not possible to sufficiently raise the temperature for the heat treatment so as to avoid coalescence between the nanoparticles, whereas according to the manufacturing method of the present invention, the heat treatment can be carried out at a high temperature, whereby the ordering is promoted to obtain the ordered alloy phase nanoparticle having a high magnetic anisotropy.

Furthermore, since the ordered alloy phase nanoparticle obtained according to the present invention is dispersible in a liquid, application thereof on a substrate by spin coating and the like makes it possible to manufacture an ultra-high-density magnetic recording medium in which desirably each particle stores one bit of data.

### BRIEF DESCRIPTION OF THE DRAWINGS

FIG. 1 is a schematic diagram showing a method of manufacturing an ordered alloy phase nanoparticle according to the present invention.

FIG. 2 is a schematic diagram showing a method of simultaneously carrying out coating removal and dispersion into an organic solvent.

FIG. 3 shows TEM images of a SiO₂ coated-FePt nanoparticle taken (a) before and (b) after a heat treatment (900° C., 1 hour).

FIG. 4 is a graph showing results of a powder X-ray diffraction of the SiO₂ coated-FePt nanoparticle.

FIG. 5 is a magnetization curve of the SiO₂ coated-FePt nanoparticle after heat treatment (900° C., 1 hour).

FIG. 6 is a graph showing a relation between the temperatures of the heat treatment and coercivity of the SiO₂ coated-FePt nanoparticle.

FIG. 7 is a TEM image of an L1₀ phase FePt nanoparticle in an aqueous solution after coating removal process.

FIG. 8 is a magnetization curve obtained when an external magnetic field is applied to the L1₀ phase FePt nanoparticle in an aqueous solution after the coating removal process, and the aqueous solution is cooled to 200K.

FIG. 9 is a TEM image of the L1₀ phase FePt nanoparticle dispersed in a chloroform solution when coating removal and dispersion in an organic solvent are carried out in the same process.

FIG. 10 is a TEM image of the L1₀ phase FePt nanoparticle dispersed in a chloroform solution when the concentration of NaOH aqueous solution is set to 2M and the coating removal and the dispersion in an organic solvent are carried out in the same process.

FIG. 11 is a conceptual diagram of magnetic separation.

FIG. 12 is a TEM image of an L1₀ phase FePt nanoparticle dispersed in a chloroform solution obtained by utilizing magnetic separation.

### EXPLANATION OF NUMERALS

1 . . . Alloy Nanoparticle
2 . . . Ordered Alloy Phase Nanoparticle
3 . . . Coating

### BEST MODE FOR CARRYING OUT THE INVENTION

The present invention is applicable to any alloy which can be ordered by heat treatment. In particular, for use as a magnetic recording medium, the alloy has desirably a high magnetic anisotropy even in the form of a nanoparticle. Preferable examples of the alloy of this kind include FePt, FePd, CoPt, CoPd (hereinafter referred to as FePt type alloy) and the like. It is desirable that the size of the nanoparticle be properly adjusted in the range of about 1 to 30 nm. Here, it is desirable that the composition ratio of the elements Fe:Pt in the alloy be set in an atomic ratio of about 4:6 to 7:3. Meanwhile, since the ordered alloy nanoparticle of the present invention has a high coercivity, for easier recording of data, a control is in some cases necessary to reduce the coercivity on purpose. In those cases, by including a slightly higher ratio of Fe or Co in the aforementioned alloy composition ratio, it is possible to reduce the coercivity and at the same time increase the residual magnetization. A high residual magnetization is advantageous in a readout of data. In the nanoparticle of a FePt type alloy, it is possible to obtain particles with a uniform size by various established methods. For example, the method proposed by Sun et al. in Non-Patent Document 1 may be used. According to the method, it is possible to control the composition and size of the FePt nanoparticle.

One of the most significant features of the method of manufacturing an ordered alloy phase nanoparticle of the present invention is that the periphery of each alloy nanoparticle is covered with a coating in order to prevent the coalescence between the alloy nanoparticles during the heat treatment. It is necessary for this coating to use materials which do not react with an alloy inside the coating and are resistant to the temperatures of the heat treatment. Coalescence of coatings may occur in the heat treatment as long as the alloy nanoparticle does not coalesce with each other. Preferable examples of a coating having the aforementioned characteristics include oxides such as SiO₂, Al₂O₃ and TiO₂. Those oxides can be dissolved by immersion in an acid or alkali solution having low reactivity with the alloy nanoparticle covered inside, and therefore it is simple to collect only the ordered alloy phase nanoparticles after the heat treatment. Taking SiO₂ as an example, a common alkaline solution such as an aqueous ammonia and sodium hydrate may be used, and a common acid may be used for Al₂O₃ and TiO₂.

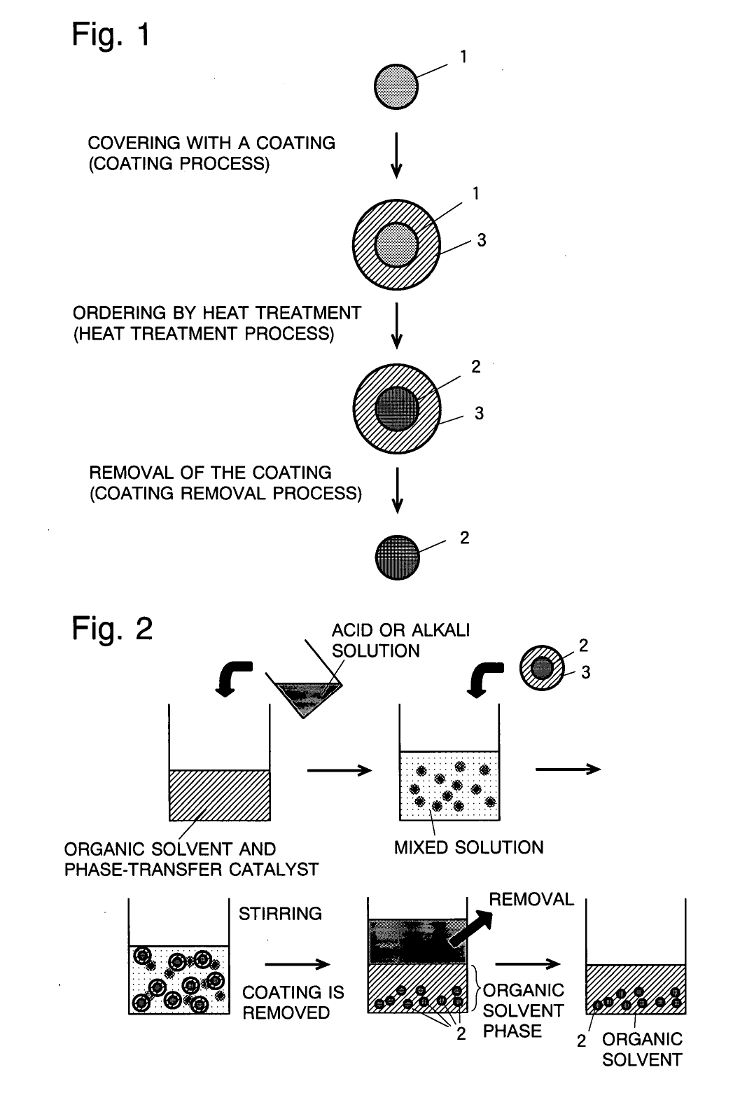

The method of manufacturing an ordered alloy phase nanoparticles of the present invention can be divided into three processes including a coating process, a heat treatment process and a coating removal process. The following description will discuss each process with reference to the schematic FIG. 1.

<Coating Process>

In this process, a coating 3 is applied around the entire periphery of each of the alloy nanoparticles 1. Any conventionally proposed method may be used for the coating method for example, a method of chemically coating metal nanocrystals with silica, which is proposed by Fan et al. in Non-Patent Document 2, can be employed. According to this method, it is possible to freely control the thickness of a SiO₂ coating by adjusting the reaction time and the amount of TEOS (TEOS: tetraethoxysilane).

<Heat Treatment Process>

By heat-treating the alloy nanoparticles 1 having the coating 3, the unordered structure of the alloy is ordered to be an ordered alloy phase nanoparticle 2. In general, a higher heat treatment temperature tends to result in a higher magnetic anisotropy due to an improved ordering, and thus it is possible to obtain an ordered alloy phase nanoparticles having desired magnetic characteristics by appropriately controlling the treatment temperature and the treatment period. In the case of the present invention, since the periphery of the alloy is covered with a coating such as SiO₂, it is necessary to perform a heat treatment at a temperature slightly higher than usual to cause ordering, and desirable conditions for the heat treatment include a temperature of 500 to 1000° C. and the treatment time of approximately one hour. A temperature of lower than 500° C. may result in insufficient ordering, and a temperature of higher than 1000° C. may result in no improvement of magnetic characteristics of the ordered alloy phase nanoparticle.

Here, it is possible to lower the temperature for heat treatment by about several hundreds degrees Celsius than usual when a starting material of the alloy nanoparticle contains 1 to 50 atomic percent of Cu or Ag, and in this case, effective ordering occurs even if the heat treatment is carried out at about 300° C. (see, for example, Non-Patent Document 3). This arrangement makes it possible to reduce processing costs, though the magnetic characteristic is slightly lowered, and thus industrial advantages can be achieved. Moreover, in order to reduce the magnetic characteristic of the particle on purpose, addition of the aforementioned metal or lowering of the heat treatment temperature may be carried out.

<Coating Removal Process>

After completing the heat treatment, only the coating 3 covering the ordered alloy phase nanoparticle 2 is removed. Any method may be used as long as only the coating 3 can be removed without having any influence on the ordered alloy phase nanoparticle 2 inside the coating. When an oxide such as SiO₂, Al₂O₃, TiO₂ and the like is used as the coating 3 as mentioned above, the coating 3 can be removed using a common acid or alkali solution. By completing the above process, it is possible to obtain the ordered alloy phase nanoparticle 2, in which each particle is present independently without coalescing with each other and the particle size is uniform. Here, when the individual particle is in a state of existing independently, the coating 3 is not necessarily removed completely. In other words, no problem occurs if the ordered alloy phase nanoparticles 2 are covered with the coating 3 having a predetermined thickness. In this structure, the coating 3 functions as a protective film, which can improve the oxidation resistance and corrosion resistance of the particles.

By using the ordered alloy phase nanoparticle obtained as mentioned above, it is possible to manufacture an ultra-high-density magnetic recording medium. Above all, the ordered alloy phase nanoparticle of the present invention has a dispersing property in various kinds of liquid. Accordingly, by dispersing the ordered alloy phase nanoparticles in an appropriate binder (a method of dispersion in the binder solution will be detailed later), it is possible to obtain a particle-dispersed binder solution in which the ordered alloy phase nanoparticles 2 are dispersed, and by spin coating the aforementioned particle-dispersed binder solution while applying an external magnetic field to the surface of the substrate in a predetermined direction, or by applying an external magnetic field after the spin coating, it is possible to form a thin magnetic film in which the axes of easy magnetization of the ordered alloy phase nanoparticles 2 are oriented in the aforementioned direction. The liquid binder is desirably cured thereafter.

In the coating removal process, at a stage when the coating has been removed in a liquid such as an acid or alkali solution, the oxide (impurity) such as SiO₂ is left in the solution. By adding an excessive amount of a liquid for separating an impurity to this solution in which the coating removal has been carried out, and then subjecting it to centrifugation and drying, it is possible to collect only an ordered alloy phase nanoparticle 2. Thereafter, further dispersion in various kinds of solution is desirably carried out. The liquid for separating an impurity may be any liquid as long as the liquid can be mixed with the liquid in which the coating removal has been carried out.

Although the ordered alloy phase nanoparticle 2 is dispersible in various kinds of liquid as mentioned above, presumably it is more likely to be dispersed in an organic solvent for industrial use. In the case where the ordered alloy phase nanoparticle 2 is dispersed in an organic solvent, in order to increase the dispersibility of the particle which is hydrophilic, it is desirable that the surface of the particle be coated with a surfactant. The type of the surfactant is not particularly limited, and may be appropriately selected depending on the organic solvent. For example, those compounds represented by the general formula R1-COOH or R2-NH₂ (R1 and R2 independently represents any of a hydrocarbon group having one or more carbons, an aromatic hydrocarbon group having one or more carbons or a halogenated hydrocarbon group having one or more carbons, from each of which one hydrogen atom is removed) which are commonly used as a surfactant, may be also used in the present invention.

It is possible to disperse the ordered alloy phase nanoparticle 2 of the present invention by using an appropriate surfactant as mentioned above. Examples of the organic solvent which can be used desirably include hydrocarbons, aromatic hydrocarbons, halogenated hydrocarbons, ethers, cyclic ethers, alcohols, keton aldehydes and the like, although of course not limited thereto.

Furthermore, both of the above processes of removing the coating 3 covering the ordered alloy phase nanoparticle 2 and dispersion in an organic solvent may be carried out at one time as will be discussed in the following. Carrying out both of the processes simultaneously can simplify the processing operations, thus providing industrial advantages. A schematic diagram of this process is shown in FIG. 2.

A mixed solution including an acid or alkali solution for coating removal, an organic solvent for dispersing the ordered alloy phase nanoparticles 2 and a phase-transfer catalyst is prepared, and the ordered alloy phase nanoparticles 2 after the heat treatment is added to the mixed solution, and then stirred until the coating 3 has a predetermined thickness.

The phase-transfer catalyst to be used hereby is a predetermined surfactant having both the function of mixing the acid or alkali solution with the organic solvent and the function of inducing the dispersion of the ordered alloy phase nanoparticle 2 in the organic solvent.

After completion of stirring, an acid or alkali solution phase containing the dissolved coating 3 and an organic solvent phase containing the ordered alloy phase nanoparticle 2 are separated from each other. The phase-transfer catalyst is contained in both the acid or alkali solution phase and the organic solvent phase. By collecting only the organic solvent from them, it is possible to obtain the ordered alloy phase nanoparticle 2 dispersed in the organic solvent.

In the above method, in order to increase the yield of the ordered alloy phase nanoparticle 2 by further removing impurities contained in an organic solvent which contains the ordered alloy phase nanoparticle 2, centrifugal separation may be appropriately carried out to collect only the ordered alloy phase nanoparticle 2, and then the ordered alloy phase nanoparticle 2 is redispersed in a predetermined organic solvent. In the case of carrying out the redispersion, a surfactant which is different from the phase-transfer catalyst may be used.

When an ultra-high-density magnetic recording medium is manufactured using the ordered alloy phase nanoparticle 2 of the present invention, the ordered alloy phase nanoparticle 2 is once dispersed in an organic solvent, and the organic solvent is mixed with a binder solution so that a particle-dispersed binder solution in which the ordered alloy phase nanoparticle 2 is dispersed can be obtained. The binder may be any kind of binder which is conventionally used for recording media, and the examples thereof include a polyurethane resin, a polyester resin, a vinyl resin, an epoxy resin, a cellulose resin, a melamine resin, a phenol resin, a polyamide resin, an acrylic resin, a styrene-butadiene copolymer, a butadiene-acrylonitrile copolymer, a vylinidene chloride resin, and the like. As an organic solvent dispersible in the binder, for example, n-hexane, toluene, methylethylketone, a mixture of methylethylketone and toluene, and the like may be desirably used. Moreover, in this case, it is desirable that a saturated fatty acid, an unsaturated fatty acid, a saturate fatty acid amine, an unsaturated fatty acid amine, a mixture of a saturated fatty acid and an unsaturated fatty acid, a mixture of a saturated fatty acid amine and an unsaturated fatty acid amine, or the like is used as the surfactant.

### EXAMPLES

The present inventors conducted an experimental manufacturing of the ordered alloy phase nanoparticle according to the present invention to confirm the effectiveness.

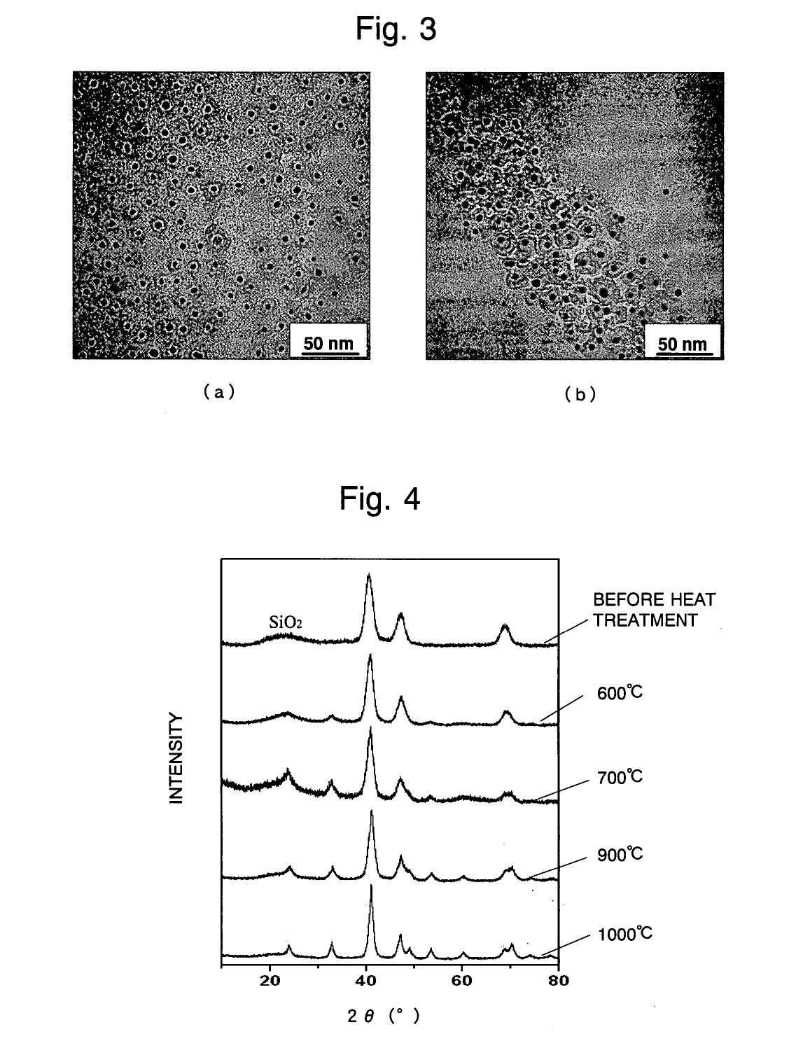

First, according to the method proposed by Sun et al. in Non-Patent Document 1, fcc FePt nanoparticles were prepared by reducing Pt(acac)₂ by 1,2-hexadecanediol in dioctylether, and simultaneously decomposing Fe(CO)₅ by heat. Next, using the method by Fan et al. disclosed in Non-Patent Document 2, the FePt nanoparticle was coated with SiO₂ by adding a TEOS solution and a NaOH solution to a solution of cetyltrimethyl ammonium bromide, in which the FePt nanoparticle obtained by the aforementioned method was dispersed, for reaction. The thus obtained SiO₂ coated-FePt nanoparticle was heat treated at various temperatures for one hour under an infusion of a mixed gas of H₂ (5%) and Ar (95%).

<Confirmation of Form>Images of the SiO₂ coated-FePt nanoparticle were taken with a Transmission Electron Microscope (TEM) (JEM-1010D, manufactured by JOEL) to check the transformation by heat treatment. A microscopic image before the heat treatment is shown in FIG. 3(a), and a microscopic image after the heat treatment at 900° C. is shown in FIG. 3(b).

FIG. 3(a) shows that the FePt nanoparticles are surely covered with the SiO₂ coating. In this microscopic image, the FePt nanoparticles had an average diameter of 6.4 mm with a standard deviation of 15%. As shown in FIG. 3(b), the FePt nanoparticles were not coalesced with each other (although the coatings were coalesced with each other) and kept a spherical shape even after the heat treatment. Also in the case of FIG. 3(b), the FePt nanoparticles had an average diameter of 6.4 mm with a standard deviation of 15%, and thus no transformation has occurred.

<Confirmation of Phase Transformation>In order to confirm changes in structural features of SiO₂ coated-FePt nanoparticles, a powder X-ray diffraction (XRD) analysis using Cu—K_{α} radiation (wavelength: 0.154 nm) was carried out by using RINT2500, manufactured by RIGAKU Corporation. The results are as shown in FIG. 4. FIG. 4 shows diffraction patterns of the SiO₂ coated-FePt nanoparticles before and after the heat treatments at 600° C., 700° C., 900° C. and 1000° C.

The diffraction pattern before the heat treatment shown in FIG. 4 has three distinctive peaks, which show that FePt has an fcc structure. Moreover, the SiO₂ peak was observed at around 2θ=22°. It was clearly observed that ordering progressed and the phase changed to the L1₀ phase when the heat treatment temperature was 700° C. or more. On the other hand, between the treatment temperatures of 900° C. and 1000° C., almost no change was observed in the diffraction pattern showing the L1₀ phase. This result indicates that ordering to the L1₀ phase should almost be fully complete with this range of treatment temperatures.

<Confirmation of Magnetic Characteristics>

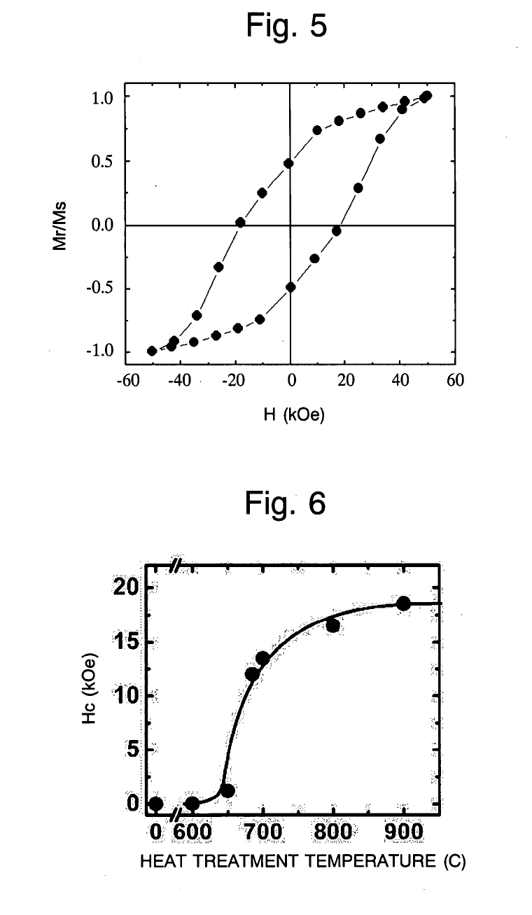

The magnetic characteristics of the SiO₂ coated-FePt nanoparticle were confirmed by using an MPMS XL superconducting quantum interference device, manufactured by Quantum Design. FIG. 5 shows a magnetization curve at room temperature of the SiO₂ coated-FePt nanoparticle after the heat treatment at a temperature of 900° C. In FIG. 5, Mᵣ in the vertical axis of the graph is a residual magnetization, and Mₛ is a magnetization at a magnetic field of 50 kOe.

FIG. 6 is a graph showing a coercivity Hc of the SiO₂ coated-FePt nanoparticle at 300K after the heat treatments at 600° C., 700° C., 800° C. and 900° C. This graph also shows that the coercivity increased with the heat treatment temperature. Though the diameter of the nanoparticle was about 6.5 nm as mentioned above, the coercivity measured was as high as 18.5 kOe when the heat treatment was carried out at 900° C.

<Removal of Coating>

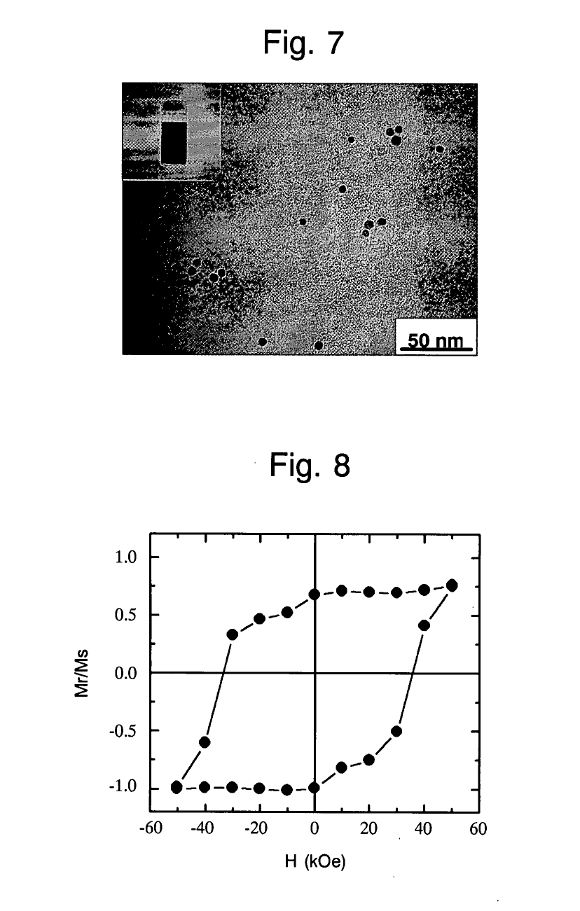

Utilizing the solubility of SiO₂ and the insolubility of FePt nanoparticles in alkali, by using tetramethylammounium hydroxide (10 wt %), only the Sio₂ coating was dissolved and removed from the heat-treated SiO₂ coated-FePt nanoparticles. FIG. 7 shows a TEM image of the L1₀ phase FePt nanoparticles in the aqueous solution obtained in this manner. It was observed that particles having a uniform size, each keeping a spherical form, were dispersed without agglomeration. A solution containing the aforementioned L1₀ phase FePt nanoparticles is shown at the upper left of FIG. 7. With proper stirring, this solution had been stable at least for one month.

<Magnetic Characteristic After Coating Removal>

FIG. 8 is a magnetization curve measured when an external magnetic field of 50 kOe was applied to the L1₀ phase FePt nanoparticle dispersed in a tetramethylammonium hydroxide solution, which was then cooled to 200K. Since the shape of a hysteresis curve was almost a rectangle, and the residual magnetization value at zero magnetization was equal to the value obtained when an external magnetization of ±50 kOe was applied, it was confirmed that an axis of easy magnetization of each SiO₂ coated-FePt nanoparticle is aligned in parallel with the direction of the applied external magnetic field.

<Separation of Impurities, Dispersion in Solution 1>

The heat-treated SiO₂ coated-FePt nanoparticle (0.5 g) was reacted with a tetramethylammonium hydroxide solution (25 wt %, 50 g) so that only the SiO₂ coating which covered the L1₀ phase FePt nanoparticle was dissolved and removed. To the resulting solution was added 100 g of water, and then centrifugation was performed at 10000 rpm for 20 minutes so that the L1₀ phase FePt nanoparticles were collected. The particles were dried at a room temperature (about 20° C.) for 12 hours, and dispersed in a solution including 25 ml of hexane, 0.05 ml of oleic acid and 0.05 ml of oleyl amine, and as a result of this, it was confirmed that the particles of the present invention were dispersible in a solution.

<Separation of Impurities, Dispersion in Solution 2>

The following experiment was carried out to confirm the effectiveness of a method of carrying out the coating removal process after the heat treatment and the process of dispersion in an organic solvent in one process.

The SiO₂ coated-FePt nanoparticle (0.03 g), 3 g of NaOH solution (concentration: 4M) as an alkali solution for carrying out the coating removal, 5 g of chloroform as an organic solvent, and 0.5 g of hexadecyltrimethylammonium bromide as a phase-transfer catalyst were mixed together and stirred for 24 hours.

After stirring, 15 g of chloroform was added to the reaction solution, and centrifugation at 5000 rpm for 10 minutes was performed to extract from the reaction solution a chloroform phase containing the L1₀ phase FePt nanoparticle. With this treatment, NaOH as well as SiO₂ dissolved in the NaOH were removed.

Next, in order to remove the hexadecyltrimethylammonium bromide that is excessively present in the chloroform phase, 40 g of ethanol was added to the extracted chloroform phase, and centrifugation at 10000 rpm was carried out for 10 minutes to collect FePt nanoparticles as a precipitate. With this treatment, impurities soluble in ethanol were also removed.

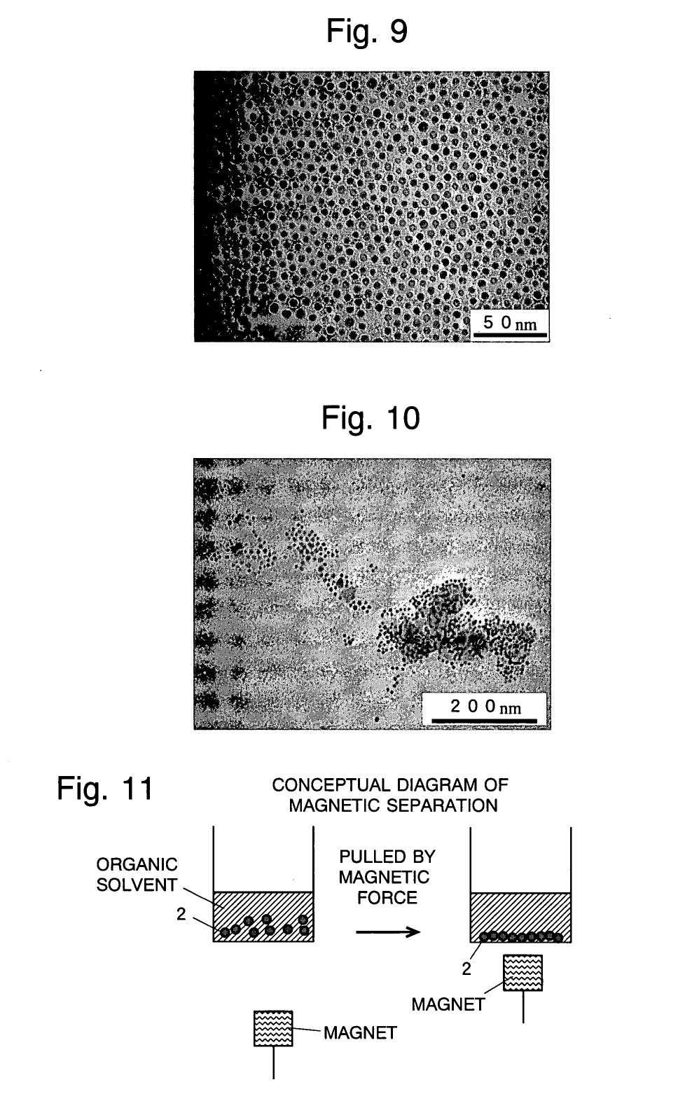

Moreover, the FePt nanoparticle collected as a precipitate was redispersed in a chloroform solution including 0.1 g of oleic acid and 0.1 g of oleyl amine so as to remove a large size L1₀ phase FePt nanoparticle and other impurities. The oleic acid and the oleyl amine to be used herein are a surfactant readily adsorbed to Fe and a surfactant readily adsorbed to Pt, respectively. The resultant solution was centrifuged at 7500 rpm for 5 minutes to remove precipitates so that the L1₀ phase FePt nanoparticle dispersed in the chloroform solution was obtained. FIG. 9 shows a TEM image of the L1₀ phase FePt nanoparticle dispersed in the chloroform solution obtained by the above method. Observation found that uniform sized L1₀ phase FePt nanoparticles were finely dispersed. Moreover, no residual undissolved SiO₂ was observed.

<Separation of Impurities, Dispersion in Solution 2: Comparison>

Experiments were carried out as in the same manner as the above experiment (basic conditions), except that various conditions were changed.

The influence of the concentration of the NaOH solution on the yield of the L1₀ phase FePt nanoparticle was investigated.

The concentration of the NaOH solution was set to 2M. FIG. 10 shows a TEM image of the L1₀ phase FePt nanoparticles dispersed in a chloroform solution obtained under this condition. It was confirmed that the L1₀ phase FePt nanoparticles were dispersed without agglomeration, while the SiO₂ remained undissolved. The yield was reduced due to the unremoved SiO₂.

Experiments were carried out using a NaOH solution of various concentrations. It was confirmed that the L1₀ phase FePt nanoparticle was finely dispersed without the residual undissolved SiO₂ when the concentration of the NaOH solution was in the range of 3M and 5M. When the concentration of NaOH solution is low, the amount of NaOH used can be reduced. Also, extraction of the chloroform phase after stirring can be more easily carried out. When the concentration of the NaOH solution is 5M or more, mixing with chloroform becomes difficult, resulting in a reduced yield of the L1₀ phase FePt nanoparticle.

Experiments were performed to investigate the influence of the weight ratio of the NaOH solution and the chloroform on the yield of the L1₀ phase FePt nanoparticle.

When the amount of the NaOH solution (concentration: 4M) was changed to 6 g (NaOH solution/chloroform=1.2) in the basic conditions, the yield of the L1₀ phase FePt nanoparticle was reduced.

When the amount of the chloroform was changed to 10 g (NaOH solution/chloroform=0.3) in the basic conditions, the yield of the L1₀ phase FePt nanoparticle was reduced.

The result showed that a preferable weight ratio of the NaOH solution and the chloroform (NaOH solution/chloroform) was in the range of 0.3 to 1.2.

Experiments were performed to investigate a preferable amount of the hexadecyltrimethylammonium bromide.

When the amount of the hexadecyltrimethylammonium bromide was changed to 0.1 g (one fifth of the basic condition) in the basic conditions, the yield of the L₀ phase FePt nanoparticle was reduced. Here, the ratio of the amount of hexadecyltrimethylammonium bromide to the total amount of the solvent (NaOH solution and chloroform) was 0.0125 (0.1 g/(3 g+5 g)=0.0125).

The result showed that even when a predetermined amount or more of hexadecyltrimethylammonium bromide, which was a phase-transfer catalyst, was added, there was no influence on the yield of the L1₀ phase FePt nanoparticle. It was thus confirmed that a preferable ratio of the amount of hexadecyltrimethylammonium bromide to the total amount of the solvent (NaOH solution and chloroform) was 0.0125 or more.

When each oleic acid, a mixture of oleic acid and oleyl amine, or trioctylmethylammonium chloride was used in place of hexadecyltrimethylammonium bromide, the yield was largely reduced.

<Separation of Impurities, Dispersion in Solution 3>

Since the ordered alloy phase nanoparticle of the present invention has high magnetic characteristics, by utilizing the magnetic characteristics, it is possible to efficiently carry out the treatment for the separation of impurities as shown in FIG. 11. The following description will describe one example of the experiment using the magnetic separation.

1) The SiO₂ coated FePt nanoparticle (0.03 g) was stirred for 12 hours in 10 g of NaOH solution (concentration: 2M) to dissolve the SiO₂ coating.

2) L1₀ phase FePt nanoparticle was collected by magnetic separation, and NaOH containing SiO₂ was removed. Thereafter, a series of redispersion in a NaOH solution (concentration: 2M) and magnetic separation were further repeated twice.

3) The collected L1₀ phase FePT nanoparticle was redispersed in 3 g of a NaOH solution (concentration: 2M), and to this solution were further added 5 g of chloroform and 0.5 g of hexadecyltrimethylammonium bromide, followed by stirring for 24 hours.

4) After completion of stirring, only the chloroform phase was taken out so as to obtain the L1₀ phase FePt nanoparticle dispersed in the chloroform.

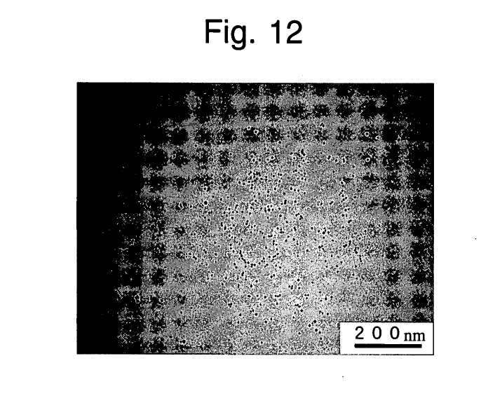

FIG. 12 shows a TEM image of the L1₀ phase FePt nanoparticle dispersed in the chloroform solution obtained by the present method. It was observed that the nanoparticles were finely dispersed and no impurities were present.

The method of manufacturing an ordered alloy phase nanoparticle according to the present invention has been described in the above by taking one example; however, it goes without saying that the ordered alloy phase nanoparticle of the present invention can be applied not only to recording media but to a variety of fields by using the excellent magnetic characteristics. For example, it is possible to manufacture a permanent magnet in which the ordered alloy phase nanoparticle of the present invention is used. By dispersing in a resin such as a thermosetting resin or an ultraviolet curing resin and the like, and curing the resin while applying a magnetic field to a predetermined direction, it is possible to obtain a magnet provided with almost no defects and unprecedented excellent characteristics.

1. A method of manufacturing an ordered alloy phase nanoparticle, comprising:
a coating process for covering each of an alloy nanoparticle with a coating;
a heat treatment process for carrying out a heat treatment for ordering a structure of the alloy nanoparticle; and
a coating removal process for removing the coating to have a predetermined thickness or completely.

2. The method of manufacturing an ordered alloy phase nanoparticle according to claim 1, wherein:
the alloy is one selected from the group consisting of FePt, FePd, CoPt, and CoPd.

3. The method of manufacturing an ordered alloy phase nanoparticle according to claim 1, wherein:
the coating is a metal oxide; and
in the coating removal process, the metal oxide is removed to have a predetermined thickness or completely by an acid or alkali solution having low reactivity with the alloy.

4. The method of manufacturing an ordered alloy phase nanoparticle according to claim 3, wherein:
in the coating removal process, after removing the metal oxide, an excessive amount of a liquid for separating an impurity is further added to the acid or alkali solution; and
centrifugation is carried out to collect only an ordered alloy phase nanoparticle.

5. The method of manufacturing an ordered alloy phase nanoparticle according to claim 1, wherein:
the coating is a metal oxide; and
the coating removal process includes:
after the heat treatment process, adding the alloy nanoparticle to a mixed solution including an acid or alkali solution having low reactivity with the alloy, an organic solvent and a phase-transfer catalyst;
stirring the mixed solution so that the metal oxide is removed to have a predetermined thickness or completely; and
collecting only an organic solvent phase containing an ordered alloy phase nanoparticle to obtain the ordered alloy phase nanoparticle dispersed in the organic solvent.

6. The method of manufacturing an ordered alloy phase nanoparticle according to claim 5, wherein:
the alkali solution is NaOH solution;
the organic solvent is chloroform; and
the phase-transfer catalyst is hexadecyltrimethylammonium bromide.

7. The method of manufacturing an ordered alloy phase nanoparticle according to claim 3, wherein:
the metal oxide is one selected from the group consisting of SiO2, Al2O3, and TiO2.

8. The method of manufacturing an ordered alloy phase nanoparticle according to claim 1, wherein:
a heat treatment temperature in the heat treatment process is from 600 to 1000° C.

9. The method of manufacturing an ordered alloy phase nanoparticle according to claim 1, wherein:
the alloy contains 1 to 50 atomic percent of Cu or Ag; and
the heat treatment temperature in the heat treatment process is from 300 to 1000° C.

10. A method of manufacturing an ultra-high-density magnetic recording medium, comprising:
dispersing the ordered alloy phase nanoparticle obtained by the manufacturing method according to claim 1 in a binder solution to prepare a particle-dispersed binder solution; and
spin-coating the particle-dispersed binder solution onto a substrate while applying a predetermined magnetic field to the substrate, or spin-coating the particle-dispersed binder solution onto a substrate and then applying a predetermined magnetic field to the substrate.

11. The method of manufacturing the ultra-high-density magnetic recording medium according to claim 10, wherein:
the particle-dispersed binder solution is manufactured by dispersing an ordered alloy phase nanoparticle in an organic solvent containing a surfactant, and mixing the organic solvent with a binder solution.

12. A magnet manufactured by dispersing the ordered alloy phase nanoparticle obtained by the manufacturing method according to claim 1 in a resin, and hardening the resin while applying a predetermined magnetic field.

13. An ordered alloy phase nanoparticle, which is manufactured by the method according to claim 1.

14. An ultra-high-density magnetic recording medium, which is manufactured by the method according to claim 10.

15. The method of manufacturing an order alloy phase nanoparticle according to claim 5, wherein:
the metal oxide is one selected from the group consisting of SiO₂, Al₂O₃, and TiO₂.
